(19) United States
(12) Patent Application Publication
(10) Pub. No.: US 2012/0139382 A1
(43) Pub. Date: Jun. 7, 2012

(54) END PLATE, AND ROTOR FOR ROTARY ELECTRIC MACHINE WHICH EMPLOYS THE END PLATE

(75) Inventors: Yoshitada YAMAGISHI, Toyota-shi (JP); Yoshihiko UKAI, Nagoya-shi (JP)

(73) Assignee: TOYOTA JIDOSHA KABUSHIKI KAISHA, Toyota-shi (JP)

(21) Appl. No.: 13/311,095

(22) Filed: Dec. 5, 2011

(30) Foreign Application Priority Data
Dec. 6, 2010 (JP) 2010-271892

(51) Int. Cl. H02K 1/28

(52) U.S. Cl. 310/156.61

(57) ABSTRACT

An end plate is made of a magnetic material, and holds an axis-direction end surface of a rotor core in which a permanent magnet is buried. The end plate includes: a protruded portion constructed so as to be caused to pressingly contact the axis-direction end surface of the rotor core when mounted in the rotor; and a depressed portion constructed so as not to contact the axis-direction end surface. The protruded portion is formed so as to contact only one of a d-axis magnetic path region and a q-axis magnetic path region that are formed by the permanent magnet within the rotor core.

### INCORPORATION BY REFERENCE

The disclosure of Japanese Patent Application No. 2010-271892 filed on Dec. 6, 2011 including the specification, drawings and abstract is incorporated herein by reference in its entirety.

### BACKGROUND OF THE INVENTION

1. Field of the Invention

The invention relates to an end plate and, more particularly, to an end plate for use in a buried permanent magnet type rotor of a rotary electric machine.

2. Description of Related Art

There are known rotary electric machines, such as electric motors, electricity generators, etc., each of which includes a rotor of a buried magnet type that is rotatably supported, and a hollow cylindrical stator that is disposed around the rotor, wherein the rotor is rotationally driven by rotating magnetic fields formed within the stator.

The rotor usually includes a rotor shaft, and a cylindrical rotor core that is fixed to the rotor shaft. In some cases, the rotor core is formed as a steel sheet laminate in which many magnetic steel sheets are laminated, and is fixed to the rotor shaft by a method such as swaging or the like.

The permanent magnets buried in the rotor core are provided equidistantly in a circumferential direction of the rotor core in internal portions of the rotor core in the vicinity of an outer peripheral surface of the rotor core. These permanent magnets are inserted into the rotor core through magnet insert holes that have openings in end surfaces of the rotor core in the axis direction. In some cases, the permanent magnets are fixed within the rotor core by a resin that is charged into the magnet insert holes or resin charge holes next to magnet insert holes.

In some cases, when a rotor core in which permanent magnets are buried is fixed to a rotor shaft as described above, the rotor core is clamped by end plates that are disposed on respective sides of the rotor core in the axis direction. The end plates perform a function of pressing and holding the rotor core, which is a steel sheet laminate, from both sides thereof in the axis direction. In order to sufficiently perform the function, it is a general practice to form the end plates into a shape comparable to the shape of an end portion of the rotor core in the axis direction, for example, a circular disc shape.

According to the related art, the end plates are often formed from a non-magnetic metal material such as aluminum, copper, etc. This is because while the end plates are required to have high rigidity in order to apply large pressing force to the rotor core, it is necessary to prevent magnetic fluxes produced from the end portions of the permanent magnets from short-circuiting via the end plates. However, since the non-magnetic metal materials, such as aluminum, copper, etc., are high in cost and relatively low in rigidity in comparison with magnetic materials such as iron sheets, steel sheets, etc., it is currently considered to form end plates from a magnetic material in order to reduce the production cost.

For examples, Japanese Patent Application Publication No. 2003-134705 (JP-A-2003-134705) describes that end plates are formed from a magnetic material, and permanent magnets are formed so that end surfaces of the permanent magnets in the axis direction thereof are flush with external surfaces of the end plates, thereby achieving the prevention of the short-circuiting of magnetic fluxes that are produced from terminal ends of the permanent magnets and also achieving the formation of end plates from a low-cost magnetic material.

However, if the permanent magnets are formed so as to extend to the external surfaces of the end plates as in Japanese Patent Application Publication No. 2003-134705 (JP-A-2003-134705), this formation results in an increased amount of magnet portions that do not contribute to the rotating torque of the rotary electric machine. There is also another problem. That is, since the end plates made of the magnetic material are in contact with the permanent magnets at internal surfaces of the through holes formed in the end plates, large amounts of magnetic fluxes that are produced from end portions of the permanent magnets flow in the end plates, so that the eddy current loss becomes great.

### SUMMARY OF THE INVENTION

The invention provides an end plate capable of restraining occurrence of eddy current loss while reducing the production cost, and a rotor for a rotary electric machine which employs the end plate.

A first aspect of the invention relates to an end plate that is made of a magnetic material, and that is for use in a rotor of a rotary electric machine, and that holds an axis-direction end surface of a rotor core in which a permanent magnet is buried. This end plate includes: a protruded portion constructed so as to be caused to pressingly contact the axis-direction end surface of the rotor core when mounted in the rotor; and a depressed portion constructed so as not to contact the axis-direction end surface. The protruded portion is formed so as to contact only one of a d-axis magnetic path region and a q-axis magnetic path region that are formed by the permanent magnet within the rotor core.

The end plate may be constructed of one of a steel sheet and an iron sheet that are made of a magnetic material, and the protruded portion may be bent relative to a flat surface portion that the depressed portion forms.

Besides, the protruded portion may extend radially from a vicinity of a rotor shaft insert hole that is formed at a center of the end plate.

Besides, a swage portion that is swaged and fixed to a rotor shaft that extends through the rotor core and is fixed to the rotor core may be provided integrally with the end plate.

A second aspect of the invention relates to a rotor for a rotary electric machine which includes: the end plate described above; a buried permanent magnet type rotor core clamped from each of two sides in an axis direction by the end plate; and a rotor shaft that extends through the rotor core and is fixed to a center of the end plate and a center of the rotor core.

According to an end plate in accordance with the invention and a rotor for a rotary electric machine which employs the end plate, the protruded portion of the end plate made of a magnetic material is formed so that the end plate contacts only one of the d-axis magnetic path region and the q-axis magnetic path region and does not contact the other one of the regions on an end surface of the rotor core. Therefore, the magnetic fluxes produced from end portions of the permanent magnet can be restrained from short-circuiting via the end plate. As a result, the end plate can be formed form a low-cost magnetic material, and the eddy current loss that occurs in the end plate can be restrained.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a perspective view showing a state in which an end plate of the embodiment is attached to a rotor core while omitting the illustration of a rotor shaft;

FIG. 2 is a sectional view taken on line II-II in FIG. 1;

FIG. 3 is a partial side view showing a state in which the end plate contacts only a q-axis magnetic path region on a rotor core end surface;

FIG. 4 is a partial side view showing a state in which the end plate contacts only a d-axis magnetic path region on the rotor core end surface;

FIG. 5 is a partial side view similar to the view in FIG. 3 which shows an example in which one magnetic pole is formed by one permanent magnet;

FIG. 6 is a partial side view similar to the view in FIG. 3 which shows an example in which one magnetic pole is formed by two permanent magnets; and

FIG. 7 is a partial side view similar to the view in FIG. 3 which shows an example in which one magnetic pole is formed by four permanent magnets.

### DETAILED DESCRIPTION OF EMBODIMENTS

Hereinafter, embodiments of the invention will be described in detail with reference to the accompanying drawings. In the description below, concrete shapes, materials, numbers, directions, etc. are mere illustrations for facilitating the understanding of the invention, and can be changed as appropriate in accordance with uses, purposes, specifications, etc.

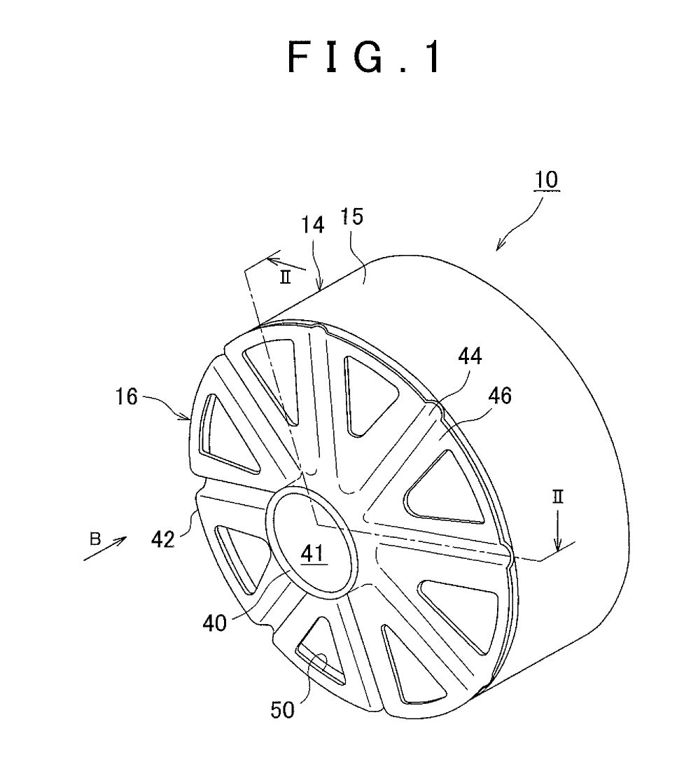

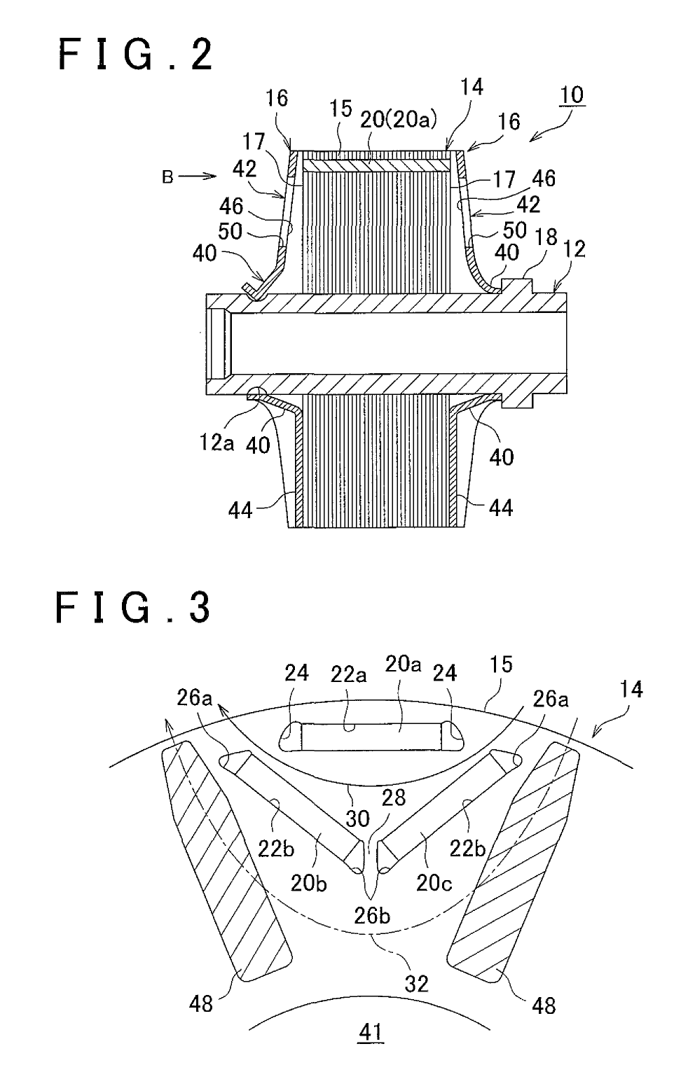

FIG. 1 is a perspective view showing a rotor 10 for a rotary electric machine which includes an end plate 16 of an embodiment of the invention while omitting the illustration of a rotor shaft. FIG. 1 shows only an end plate 16 that is provided on one of sides of the rotor 10 in the direction of an axis of the rotor 10. Besides, FIG. 2 is a sectional view of the rotor 10 taken along the axis direction thereof, including the illustration of a rotor shaft 12. In the description below, a direction along a rotation center axis of the rotor shaft 12 is termed “an axis direction”, and a direction orthogonal to the axis direction is termed “a radial directions”, and a direction along the circumference of a circle drawn on a plane orthogonal to the axis about a center point that is a point on the rotation center axis is termed “a circumference direction”.

As shown in FIG. 1 and FIG. 2, the rotor 10 includes the rotor shaft 12, a rotor core 14, and the end plates 16. The rotor shaft 12 is formed from, for example, a steel material that has a hollow round rod shape. Two end portions of the rotor shaft 12 are rotatably supported by bearing members that are fixed to a motor case (not shown).

An outer periphery of an end-side portion of the rotor shaft 12 is provided with an abutment portion 18 that is protruded radially outward. An outer peripheral surface of the other end-side portion of the rotor shaft 12 is a swage groove 12a that extends circumferentially.

The rotor core 14 is a steel sheet laminate that has a hollow cylindrical external shape and that is obtained by stacking, in the axis direction, many annular steel sheets obtained by punching magnetic steel sheets, such as silicon steel sheets having a sheet thickness of, for example, 0.3 mm, or the like, into the annular sheet pieces. The laminated steel sheets are integrally linked together by a method of welding, swaging, adhesion, or any combination thereof, etc. The rotor core 14, on the rotor shaft 12 extending through a center portion of the rotor core 14, is clamped by the end plates 16 described below, and is thus fixed in position in the axis direction. Besides, the rotor core 14 is mounted on the rotor shaft 12 by a method, such as shrink-fitting, key fitting, etc., and is thereby fixed in the circumferential position relative to the rotor shaft 12.

In the rotor core 14, a plurality of permanent magnets 20 are buried in an interior of the rotor core 14 in the vicinity of the outer peripheral surface. The permanent magnets 20 are disposed equidistantly in a circumferential direction of the rotor core 14. FIG. 3 shows an example of an arrangement of permanent magnets 20 constituting a magnetic pole. As shown in FIG. 3, in the rotor 10, a magnetic pole is constructed of three permanent magnets 20a, 20b and 20c, such magnetic poles are provided equidistantly in the circumferential direction; for example, eight such magnetic poles are provided.

Each of the three permanent magnets 20a, 20b and 20c constituting a magnetic pole has an end surface shape (and a cross-sectional shape) of a generally flattened rectangle, and has substantially the same length in the axis direction as the rotor core 14. Of the three permanent magnets, a permanent magnet 20a positioned in the middle is disposed at a position in the proximity of the outer peripheral surface 15 of the rotor core 14 so that the longer-side side surface of the permanent magnet 20a is substantially parallel to the circumferential direction. The permanent magnet 20a is thus provided by inserting it into a magnet insert hole 22a that is formed so as to be geometrically similar to and slightly larger than the aforementioned end surface shape of the permanent magnet 20a. On each of both sides of the magnet insert hole 22a in the circumferential direction, there is formed a resin fill hole 24 that is to be filled with a resin for fixing the magnet. The resin fill holes 24 communicate with the magnet insert hole 22a. After all the permanent magnets are inserted into the rotor core 14, the resin fill holes 24 are filled with, for example, a thermosetting resin, and the resin is allowed to harden, so that the permanent magnets 20a are fixed within the magnet insert holes 22a.

Of the three permanent magnets 20a, 20b and 20c that constitute a magnetic pole, the other two permanent magnets 20b and 20c are disposed on respective sides of the permanent magnet 20a, with a predetermined distance left between each of the permanent magnets 20b and 20c and the permanent magnet 20a in the circumferential direction. The two permanent magnets 20b and 20c are provided so as to be open in a generally V shape toward an outer peripheral side. The permanent magnets 20b and 20c are inserted in magnet insert holes 22b that are formed so as to be geometrically similar to and slightly larger than the end surface shape of the permanent magnets 20b and 20c. On the outside of each of the magnet insert holes 22b in a radial direction, there is formed a resin fill hole 26a that is to be filled with the resin for fixing the magnet. The resin fill holes 26a of each communicate with the corresponding magnet insert holes 22b. After all the permanent magnets are inserted into the rotor core 14, the resin fill holes 26a are filled with, for example, a thermosetting resin, and the resin is allowed to harden, so that the permanent magnets 20b and 20c are fixed within the magnet insert holes 22b. In addition, each resin fill hole 26a, because of containing a resin that is lower in magnetic permeability than the magnetic steel sheet, performs a function of restraining diffraction of magnetic fluxes (i.e., leakage fluxes) around the outer peripheral side end portion of a corresponding one of the permanent magnets 20b.

An inner side of each magnet insert hole 22b in a radial direction is provided with a magnetic flux leakage restraining hole 26b that communicates with the magnet insert hole 22b. Each magnetic flux leakage restraining hole 26b is provided for restraining the diffraction of magnetic fluxes around the radially inner side end portion of a corresponding one of the permanent magnets 20b, because of containing an air gap that is lower in magnetic permeability than the magnetic steel sheet. The two magnetic flux leakage restraining holes 26b face each other across a narrow bridge portion 28.

Incidentally, the magnet insert holes, the resin fill holes and the magnetic flux leakage restraining holes may be formed extending through the entire length of the rotor core 14 in the axis direction, or may also be formed into a hole shape one of whose side ends in the axis direction is closed. Besides, the magnetic flux leakage restraining holes 26b may also be filled with a resin as is the case with the resin fill hole 26a.

The permanent magnets 20a, 20b and 20c are magnetized in a direction orthogonal to the longer-side side surface (i.e., a direction along the shorter-side side surface). Due to this, there are formed a region that forms a d-axis magnetic path shown by a solid-line arrow 30 and a region that forms a q-axis magnetic path shown by a one-dot chain-line arrow 32 within the rotor core 14, due to the magnetic fluxes that are produced from the permanent magnets 20a, 20b and 20c. Hereinafter, these regions will be termed the d-axis magnetic path region 30 and the q-axis magnetic path region 32 as appropriate.

The d-axis magnetic path region 30 includes a generally triangular region toward a radially outer side which is surrounded by the permanent magnet 20a positioned at a center of the magnetic pole and the two permanent magnets 20b and 20c at respective sides of the permanent magnet 20a in a view of one of two end surfaces 17 of the rotor core 14 from outside in the axis direction (i.e., in a direction of an arrow B in FIG. 2). On the other hand, the q-axis magnetic path region 32 includes regions that extend in radial directions between the magnetic pole and its adjacent magnetic poles in the circumferential direction, and a generally circular arc shape region that is positioned radially inward of the two resin fill holes 26b in a view of one of two end surfaces 17 of the rotor core 14 from outside in the axis direction (i.e., in the direction of the arrow B in FIG. 2).

The end plates 16 are provided for fixing the rotor core 14 by clamping it from both sides in the axis direction in a state where the rotor shaft 12 has been inserted in a core center hole. Each end plate 16 in this embodiment is a platy member that is formed from a magnetic material, and can be suitably constructed of, for example, a steel sheet, an iron sheet, etc. For the end plates 16, the same steel sheet as the magnetic steel sheets that form the rotor core 14 may be used, or a different magnetic material may also be used. Incidentally, the end plates 16 provided on respective sides of the rotor core 14 may be of the same size and the same shape while differing from each other merely in the mounting direction.

Each end plate 16 has a hollow cylindrical portion 40 that is provided so as to cover a perimeter of the rotor shaft 12, and a circular disc portion 42 that extends radially outward continuously from the hollow cylindrical portion 40, which are integral with each other. The hollow cylindrical portion 40 and the circular disc portion 42 of each end plate 16 can be integrally formed by press-molding an annular steel sheet. A minimum inside diameter of a rotor shaft insert hole 41 that is formed inside the hollow cylindrical portion 40 is slightly larger than an external dimension of the rotor shaft 12.

The hollow cylindrical portion 40 of one of the end plates 16 is constructed so as to function as a swage portion that is forced into swage groove 12a of the rotor shaft 12 and is swaged at the time of assemblage of the rotor 10.

The circular disc portion 42 of each end plate 16 includes protruded portions 44 that extend radially in radial directions from the vicinity of the rotor shaft insert hole 41 defined by the hollow cylindrical portion 40, and generally fan-shape depressed portions 46 that are formed between the protruded portions 44. In this embodiment, the number of the protruded portions 44 and the number of the depressed portions 46 are both eight, and are alternately disposed around the hollow cylindrical portion 40. That is, the number of the protruded portions 44 and the number of the depressed portions 46 each equals the number of magnetic poles of the rotor 10. It is to be noted herein that the term of “protruded portion” means that the portion is protruded toward the adjacent end surface 17 of the rotor core 14, and the term of “depressed portion” means that the portion is depressed from the adjacent end surface of the rotor core 14. These protruded portions 44 and the depressed portions 46 can also be formed during the aforementioned press-molding process.

The protruded portions 44 of each end plate 16 are bent into a generally U shape that extends from flat surface portions that form the depressed portions 46, toward the adjacent end surface of the rotor core 14. When the end plates 16 are mounted so as to assemble the rotor 10, the protruded portions 44 of each end plate 16 are placed in a pressing contact with the adjacent end surface 17 of the rotor core 14. The protruded portions 44, as shown by hatched regions 48 in FIG. 3, are formed so as to make generally belt-shape contact areas with the adjacent end surface of the rotor core 14 along the radially extending portions of the q-axis magnetic path regions 32 formed within the rotor core 14. In other words, the protruded portions 44 of each end plate 16 are formed so as not to contact the d-axis magnetic path regions 30 formed within the rotor core 14. Besides, the protruded portions 44 of each end plate 16 formed in this manner function as a rib structure of the end plate 16, so that the end plates 16 can be reduced in plate thickness while attaining high rigidity.

On the other hand, the depressed portions 46 of each end plate 16 are formed so as not to contact the rotor core 14 when mounted to assemble the rotor 10, that is, so as to be positioned apart from the adjacent end surface 17 of the rotor core 14. In the circular disc portion 42 of the end plate 16, portions that form the depressed portions 46 may be provided with a plurality of generally fan-shape through holes 50 for the purpose of weight reduction.

Next, the assemblage of the rotor 10 having the foregoing construction will be briefly described. At the time of assemblage of the rotor 10, the permanent magnets 20a, 20b and 20c have been inserted in the rotor core 14, and have been fixed by the resin charged into the resin fill holes 24, 26a and 26b. However, in the case where the rotor core 14 is fixed to the rotor shaft 12 by shrunk fitting, the permanent magnets may be buried after the rotor core 14 is fixed to the rotor shaft 12 of the rotor core 14, or it is also permissible to adopt a process in which pre-magnetization ferromagnetic elements are buried beforehand, and after the rotor core 14 is fixed to the rotor shaft 12, the ferromagnetic elements are magnetized by a magnetization device.

Firstly, a first end plate 16 (the right-side end plate in FIG. 2) is inserted over the rotor shaft 12, and the hollow cylindrical portion 40 is brought into contact with the abutment portion 18. Then, the rotor core 14 is inserted over the rotor shaft 12, and a side end surface 17 of the rotor core 14 is brought into in contact with the first end plate 16.

Then, the second end plate 16 (the left-side end plate in FIG. 2) is inserted over the rotor shaft 12, and is pressed against the other end surface 17 of the rotor core 14 by a predetermined pressing force. While this state is maintained, a portion of the hollow cylindrical portion 40 of the second end plate 16 is pressed into the swage groove 12a, and then is swaged. This fixes the two end plates 16 to the rotor shaft 12. In consequence, the rotor core 14 is fixed to the rotor shaft 12 while clamped by the two end plates 16.

In the rotor 10 assembled as described above, the protruded portions 44 of each end plates 16 are in contact with only the q-axis magnetic path regions 32 in the end surfaces 17 of the rotor core 14, and are not in contact with the d-axis magnetic path regions 30. That is, the d-axis magnetic paths and the q-axis magnetic paths within the rotor core 14 do not short-circuit with each other via the end plates 16 that are made of a magnetic material. Therefore, the magnetic fluxes that are produced from the permanent magnets 20a, 20b and 20c buried within the rotor core 14 can be restrained from flowing to the end plates 16, so that the eddy current loss within the end plates 16 can be reduced.

Besides, by forming the end plates 16 from a magnetic material, such as steel sheets, iron sheets, etc., the production cost can be lessened in comparison with the case where the end plates 16 are formed from a non-magnetic metal material, such as aluminum, copper, etc., as in the related art.

Furthermore, since the protruded portions 44 of each end plate 16 are formed as a rib structure, the end plates 16 can be reduced in the wall thickness and can be provided with such a high rigidity that a sufficient pressing force can be provided. Therefore, the end plates 16 can be further reduced in cost, and the eddy current loss, which is proportional to the plate thickness, can be further reduced.

Furthermore, according to the end plates 16 of this embodiment, the swage portion of each end plate 16 that is swaged and fixed to the rotor shaft 12 is formed as the hollow cylindrical portion 40 integrally with the end plate 16. This eliminates the need for a swage member that is adopted as a member separate from the end plates in the related art, so that a further cost reduction due to reduction of the number of component parts can be expected.

While the end plates 16 of the foregoing embodiment and the rotor 10 that employs the end plates 16 are described above, it is to be understood that the invention is not limited to the above-described constructions, but that various modifications and improvements are possible.

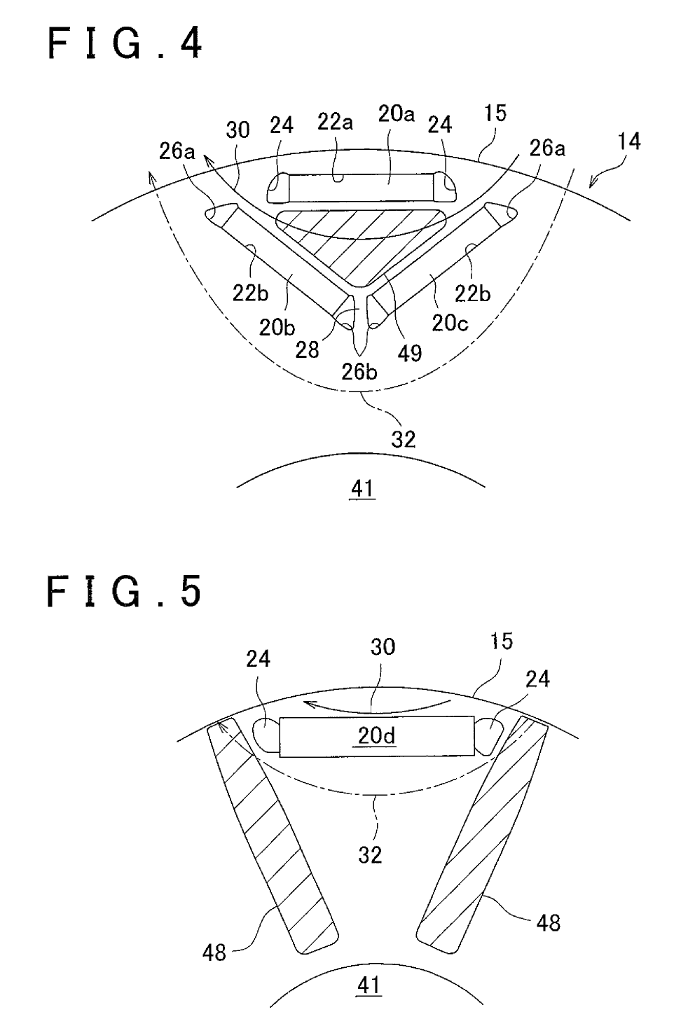

For example, although it is described above that the protruded portions 44 of each end plate 16 are constructed so as to contact only the q-axis magnetic path regions 32 on the adjacent end surface 17 of the rotor core 14, the protruded portions of each end plate may also be formed so as to contact only the d-axis magnetic path regions 30 as shown by hatched regions 49 in FIG. 4.

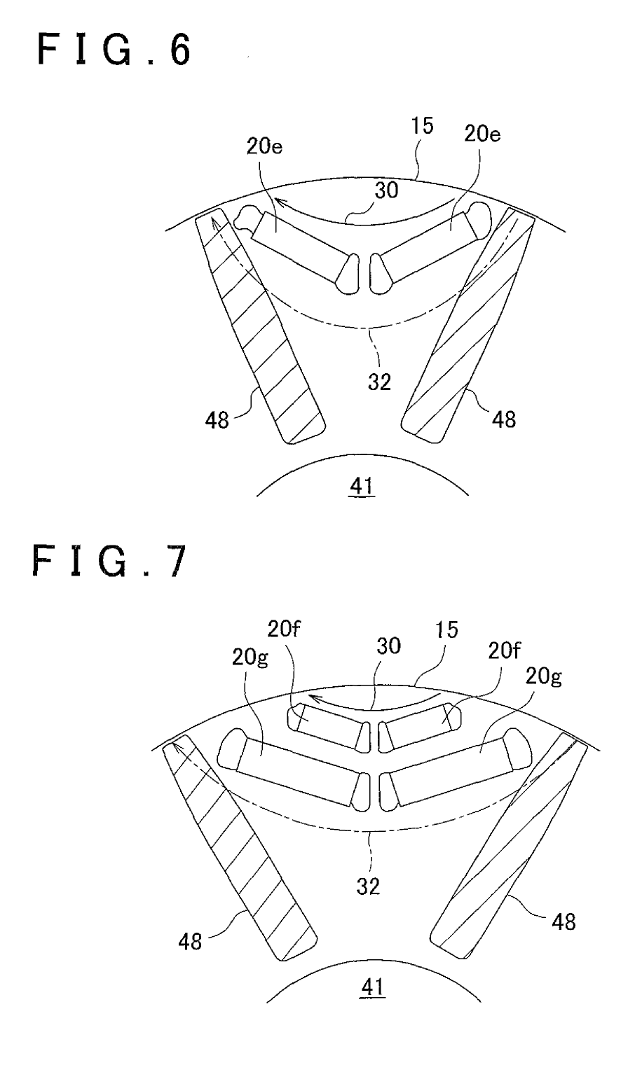

Besides, although in the foregoing embodiment, a magnetic pole of the rotor 10 is constructed by the three permanent magnets 20a, 20b and 20c buried therein, this is not restrictive, that is, the number of permanent magnets contained in a magnetic pole can be appropriately changed according to the design of the rotor or of the rotary electric machine, or the like. For example, a magnetic pole of the rotor may contain only one permanent magnet 20d as shown in FIG. 5, or may contain two permanent magnets 20e disposed in a generally V-shape arrangement as shown in FIG. 6, or may also contain four permanent magnets as shown in FIG. 7, that is, two pairs of permanent magnets 20f and 20g which are both disposed in a generally V-shape arrangement and whose V-shape arrangements are juxtaposed in a radial direction.

Furthermore, although as for the end plate of the embodiment, a magnetic material-made sheet is press-molded and the protruded portions are formed by bending, this is not restrictive. For example, each of the end plates may also be provided by welding hollow or solid steel members having a quadrilateral sectional shape (protruded portions) to a rotor core-facing surface of the circular disc-shape magnetic plate.

What is claimed is:

1. An end plate that is made of a magnetic material, and that is for use in a rotor of a rotary electric machine, and that holds an axis-direction end surface of a rotor core in which a permanent magnet is buried, comprising:
a protruded portion constructed so as to be caused to pressingly contact the axis-direction end surface of the rotor core when mounted in the rotor; and
a depressed portion constructed so as not to contact the axis-direction end surface,
wherein the protruded portion is formed so as to contact only one of a d-axis magnetic path region and a q-axis magnetic path region that are formed by the permanent magnet within the rotor core.

2. The end plate according to claim 1, wherein:
the end plate is constructed of one of a steel sheet and an iron sheet that are made of a magnetic material; and
the protruded portion is bent relative to a flat surface portion that the depressed portion forms.

3. The end plate according to claim 1, wherein
the protruded portion extends radially from a vicinity of a rotor shaft insert hole that is formed at a center of the end plate.

4. The end plate according to claim 1, wherein
a swage portion that is swaged and fixed to a rotor shaft that extends through the rotor core and is fixed to the rotor core is provided integrally with the end plate.

5. A rotor for a rotary electric machine, comprising:
the end plate according to claim 1;
a buried permanent magnet rotor core clamped from each of two sides in an axis direction by the end plate; and
a rotor shaft that extends through the rotor core and is fixed to a center of the end plate and a center of the rotor core.
